(19) United States
(12) Patent Application Publication
(10) Pub. No.: US 2026/0069981 A1
(43) Pub. Date: Mar. 12, 2026

(54) VIRTUAL OBJECT INTERACTION CONTROL METHOD, ELECTRONIC DEVICE, MEDIUM, AND COMPUTER PROGRAM PRODUCT

(71) Applicant: SHANGHAI LILITH TECHNOLOGY CORPORATION, Shanghai (CN)

(72) Inventor: Yining Li, Shanghai (CN)

(21) Appl. No.: 18/716,402

(22) PCT Filed: Mar. 15, 2024
(86) PCT No.: PCT/CN2024/081801

§ 371 Date: Jun. 4, 2024

(30) Foreign Application Priority Data
Dec. 8, 2023 (CN) 202311684419.9

(51) Int. Cl. A63F 13/577; A63F 13/56; A63F 13/837

(52) U.S. Cl. CPC A63F 13/577; A63F 13/56; A63F 13/837; A63F 2300/8076

(57) ABSTRACT

The present disclosure relates to the field of game design technologies, and in particular, to a virtual object interaction control method, a device, a computer-readable storage medium, and a computer program product. The method includes: a determining step of determining a first virtual object and a second virtual object to interact with each other; a receiving step of receiving a first interaction value that the first virtual object performs on the second virtual object and a second interaction value that the second virtual object performs on the first virtual object; and a display step of displaying a corresponding first interaction effect on the second virtual object based on the first interaction value and displaying a corresponding second interaction effect on the first virtual object based on the second interaction value.

### CROSS-REFERENCE TO RELATED DISCLOSURES

This application is a national stage application of PCT international application PCT/CN2024/081801 filed on Mar. 15, 2024, entitled “VIRTUAL OBJECT INTERACTION CONTROL METHOD, DEVICE, MEDIUM, AND COMPUTER PROGRAM PRODUCT”, which claims priority to Chinese patent application No. 2023116844199, filed on Dec. 8, 2023, the entire contents of which are incorporated herein by reference.

### TECHNICAL FIELD

The present disclosure relates to the field of game design technologies, and in particular, to a virtual object interaction control method, an electronic device, a computer-readable storage medium, and a computer program product.

### BACKGROUND

Interaction data of virtual objects during a game is generally calculated at a server, calculation results are sent by the server to clients, and the received data is finally displayed at the clients. For example, in the game, different game characters fight with each other. Damage data of a fight is calculated by the server, and then calculation results are sent to the clients. The client displays a damage effect according to the calculation results. However, in simulation games, there are a large number of virtual objects participating in interaction, and there is still a need to provide a simpler and smoother data settlement scheme at a numerical level to fully utilize performance of the server and enable the clients to support a high-frequency virtual object interaction process.

### SUMMARY

The present disclosure discloses a virtual object interaction control method, applied to an electronic device. The method includes:
a determining step of determining a first virtual object and a second virtual object to interact with each other;
a receiving step of receiving a first interaction value that the first virtual object performs on the second virtual object and a second interaction value that the second virtual object performs on the first virtual object; and
a display step of displaying a corresponding first interaction effect on the second virtual object based on the first interaction value and displaying a corresponding second interaction effect on the first virtual object based on the second interaction value.

In some embodiments, the determining step further includes determining a first hit rate of the first virtual object and a second hit rate of the second virtual object, and wherein the display step further includes displaying the corresponding first interaction effect on the second virtual object based on the first hit rate and the first interaction value, and displaying the corresponding second interaction effect on the first virtual object based on the second hit rate and the second interaction value.

In some embodiments, the display step further includes displaying at least a portion of corresponding first interaction effects on the second virtual object in a first interaction cycle based on the first hit rate and a plurality of first interaction values received before the first interaction cycle, and displaying at least a portion of corresponding second interaction effects on the first virtual object in a second interaction cycle based on the second hit rate and a plurality of second interaction values received before the second interaction cycle.

In some embodiments, the first interaction cycle and the second interaction cycle both include a hittable cycle and an unhittable cycle, and wherein the at least a portion of the corresponding first interaction effects are displayed on the second virtual object in the hittable cycle of the first interaction cycle based on the first hit rate and the plurality of first interaction values received before the first interaction cycle, and the at least a portion of the corresponding second interaction effects are displayed on the first virtual object in the hittable cycle of the second interaction cycle based on the second hit rate and the plurality of second interaction values received before the second interaction cycle, and wherein the first hit rate and the second hit rate are respectively adjusted to 0 in the unhittable cycles of the first interaction cycle and the second interaction cycle.

In some embodiments, after all the corresponding first interaction effects are displayed on the second virtual object in the hittable cycle of the first interaction cycle based on the first hit rate and the plurality of first interaction values received before the first interaction cycle, the first hit rate is adjusted to 0, and after all the corresponding second interaction effects are displayed on the first virtual object in the hittable cycle of the second interaction cycle based on the second hit rate and the plurality of second interaction values received before the second interaction cycle, the second hit rate is adjusted to 0.

In some embodiments, after all the corresponding first interaction effects are displayed on the second virtual object in the hittable cycle of the first interaction cycle based on the first hit rate and the plurality of first interaction values received before the first interaction cycle, when one or more new first interaction values are received again, the first hit rate is restored and at least a portion of corresponding first interaction effects are displayed on the second virtual object based on the first hit rate and the one or more new first interaction values, and after all the corresponding second interaction effects are displayed on the first virtual object in the hittable cycle of the second interaction cycle based on the second hit rate and the plurality of second interaction values received before the second interaction cycle, when one or more new second interaction values are received again, the second hit rate is restored and at least a portion of corresponding second interaction effects are displayed on the first virtual object based on the second hit rate and the one or more new second interaction values.

In some embodiments, after the at least a portion of the corresponding first interaction effects are displayed on the second virtual object in the hittable cycle of the first interaction cycle based on the first hit rate and the plurality of first interaction values received before the first interaction cycle, the remaining corresponding first interaction effects are continuously displayed on the second virtual object based on the first hit rate in the hittable cycle of a next first interaction cycle, and after the at least a portion of the corresponding second interaction effects are displayed on the first virtual object in the hittable cycle of the second interaction cycle based on the second hit rate and the plurality of second interaction values received before the second interaction cycle, the remaining corresponding second interaction effects are continuously displayed on the first virtual object based on the second hit rate in the hittable cycle of a next second interaction cycle.

The present disclosure discloses a virtual object interaction control system, including:
a determination unit configured to determine a first virtual object and a second virtual object to interact with each other;
a receiving unit configured to receive a first interaction value that the first virtual object performs on the second virtual object, and a second interaction value that the second virtual object performs on the first virtual object; and
a display unit configured to display a corresponding first interaction effect on the second virtual object based on the first interaction value, and display a corresponding second interaction effect on the first virtual object based on the second interaction value.

In some embodiments, the determination unit is further configured to determine a first hit rate of the first virtual object and a second hit rate of the second virtual object. The display unit is further configured to display the corresponding first interaction effect on the second virtual object based on the first hit rate and the first interaction value, and display the corresponding second interaction effect on the first virtual object based on the second hit rate and the second interaction value.

In some embodiments, the display unit is further configured to display at least a portion of corresponding first interaction effects on the second virtual object in a first interaction cycle based on the first hit rate and a plurality of first interaction values received before the first interaction cycle, and display at least a portion of corresponding second interaction effects on the first virtual object in a second interaction cycle based on the second hit rate and a plurality of second interaction values received before the second interaction cycle.

In some embodiments, the first interaction cycle and the second interaction cycle both include a hittable cycle and an unhittable cycle. The at least a portion of the corresponding first interaction effects are displayed on the second virtual object in the hittable cycle of the first interaction cycle based on the first hit rate and the plurality of first interaction values received before the first interaction cycle, and the at least a portion of the corresponding second interaction effects are displayed on the first virtual object in the hittable cycle of the second interaction cycle based on the second hit rate and the plurality of second interaction values received before the second interaction cycle, and the first hit rate and the second hit rate are respectively adjusted to 0 in the unhittable cycles of the first interaction cycle and the second interaction cycle.

In some embodiments, after all the corresponding first interaction effects are displayed on the second virtual object in the hittable cycle of the first interaction cycle based on the first hit rate and the plurality of first interaction values received before the first interaction cycle, the first hit rate is adjusted to 0, and after all the corresponding second interaction effects are displayed on the first virtual object in the hittable cycle of the second interaction cycle based on the second hit rate and the plurality of second interaction values received before the second interaction cycle, the second hit rate is adjusted to 0.

In some embodiments, after all the corresponding first interaction effects are displayed on the second virtual object in the hittable cycle of the first interaction cycle based on the first hit rate and the plurality of first interaction values received before the first interaction cycle, when one or more new first interaction values are received again, the first hit rate is restored and at least a portion of corresponding first interaction effects are displayed on the second virtual object based on the first hit rate and the one or more new first interaction values. After all the corresponding second interaction effects are displayed on the first virtual object in the hittable cycle of the second interaction cycle based on the second hit rate and the plurality of second interaction values received before the second interaction cycle, when one or more new second interaction values are received again, the second hit rate is restored and at least a portion of corresponding second interaction effects are displayed on the first virtual object based on the second hit rate and the one or more new second interaction values.

In some embodiments, after the at least a portion of the corresponding first interaction effects are displayed on the second virtual object in the hittable cycle of the first interaction cycle based on the first hit rate and the plurality of first interaction values received before the first interaction cycle, the remaining corresponding first interaction effects are continuously displayed on the second virtual object based on the first hit rate in the hittable cycle of a next first interaction cycle. After the at least a portion of the corresponding second interaction effects are displayed on the first virtual object in the hittable cycle of the second interaction cycle based on the second hit rate and the plurality of second interaction values received before the second interaction cycle, the remaining corresponding second interaction effects are continuously displayed on the first virtual object based on the second hit rate in the hittable cycle of a next second interaction cycle.

The present disclosure discloses an electronic device. The electronic device includes a processor and a memory storing a computer-executable instruction, the processor being configured to execute the instruction to implement the virtual object interaction control method.

The present disclosure discloses a computer-readable storage medium, having a computer-executable instruction stored therein. The instruction is executed by a processor to implement the virtual object interaction control method.

The present disclosure discloses a computer program product, including a computer-executable instruction. The instruction is executed by a processor to implement the virtual object interaction control method.

### BRIEF DESCRIPTION OF THE DRAWINGS

FIG. 1 is a flowchart of a virtual object interaction control method according to embodiments of the present disclosure;

FIG. 2 is another flowchart of a virtual object interaction control method according to embodiments of the present disclosure;

FIG. 3 is a structural diagram of a virtual object interaction control system according to embodiments of the present disclosure;

FIG. 4 is another structural diagram of a virtual object interaction control system according to embodiments of the present disclosure; and

FIG. 5 is a block diagram of a hardware structure of an electronic device configured to implement a virtual object interaction control system according to embodiments of the present disclosure.

### DETAILED DESCRIPTION

To make the objectives and technical solutions of the embodiments of the present disclosure more clear, the technical solutions of the embodiments of the present disclosure will be clearly and completely described below with reference to the accompanying drawings of the embodiments of the present disclosure. Apparently, the embodiments to be described are only a part rather than all of the embodiments of the present disclosure, and based on the described embodiments of the present disclosure, all other embodiments obtained by those of ordinary skill in the art without creative efforts fall within the protection scope of the present disclosure.

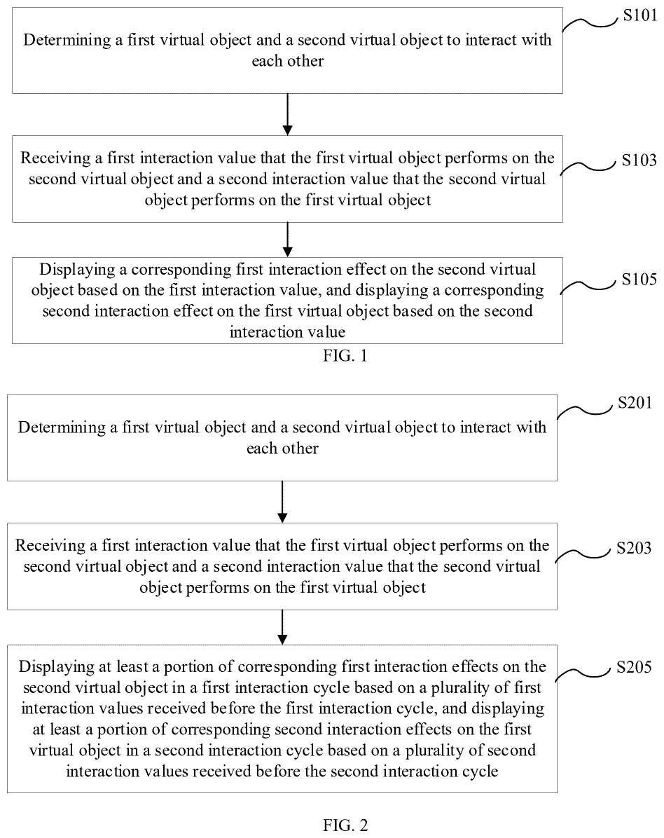

FIG. 1 is a flowchart of a virtual object interaction control method according to embodiments of the present disclosure. As shown in FIG. 1, the method provided in a first embodiment includes the following steps.

In a determining step S101, a first virtual object and a second virtual object to interact with each other are determined.

Virtual objects refer to controllable objects in a game program executed on clients, including virtual characters, virtual items, and the like. For example, for two or two groups of fighters in a war game that continuously attack each other at a fixed firing interval, the clients may determine that the two or two groups of fighters may be the first virtual object and the second virtual object to interact with each other. The two or two groups of fighters are controlled by different clients or belong to different game camps. The first virtual object is controlled by a first client, and the second virtual object is controlled by a second client. It may be understood that more virtual objects that interact with each other may be split into multiple pairs of virtual objects that interact with each other. The clients may be digital devices such as smartphones, tablet computers, notebook computers, or desktop computers, which can run a computer application program and support input and output operations.

In addition, the clients may determine the first virtual object and the second virtual object to interact with each other based on a determination rule received in advance from the server or based on a determination rule preset in the game program executed on the clients. For example, the determination rule may be determining that two fighters are the first virtual object and the second virtual object, respectively, when the two fighters controlled by the first client and the second client respectively enter a firing range.

In a receiving step S103, a first interaction value that the first virtual object performs on the second virtual object and a second interaction value that the second virtual object performs on the first virtual object are received.

Continuing with the above example, a damage value caused by each fighter to the opposing fighter may be calculated on the server side based on fight process parameters such as positions, attack values, and defense values of the two fighters. The damage value may be the first interaction value and the second interaction value, and the damage values may be sent to the clients by the server. In this embodiment, the first interaction value is a damage value caused by a fighter corresponding to the first virtual object to a fighter corresponding to the second virtual object, and the second interaction value is a damage value caused by the fighter corresponding to the second virtual object to the fighter corresponding to the first virtual object.

In a display step S105, a corresponding first interaction effect is displayed on the second virtual object based on the first interaction value, and a corresponding second interaction effect is displayed on the first virtual object based on the second interaction value.

Continuing with the above example, after receiving the damage value from the server, the client can display the damage value on the damaged fighter. For example, when the first virtual object controlled by the first client attacks the second virtual object controlled by the second client, the first interaction value is displayed on the second virtual object, i.e., a first damage value is displayed on the fighter controlled by the second client. This process of displaying the first damage value is displaying the first interaction effect. On the contrary, when the second virtual object attacks the first virtual object, the process of displaying the second interaction value (i.e., a second damage value) on the first virtual object is displaying the second interaction effect. The implementation of displaying the damage value on the fighter by the client is a conventional technical means mastered by those skilled in the art and will not be repeated.

In addition, when the first virtual object controlled by the first client attacks the second virtual object controlled by the second client, an attack effect is also displayed on the first virtual object. On the contrary, when the second virtual object attacks the first virtual object, an attack effect is also displayed on the second virtual object. The attack effect refers to an effect displayed by a fighter launching an attack, such as a special effect of cannon firing. The implementation of displaying the attack effect on the fighter by the client is a conventional technical means mastered by those skilled in the art and will not be repeated.

Therefore, in the first embodiment, the server can calculate the first interaction value and the second interaction value based only on its own calculation model and send the first interaction value and the second interaction value to the clients in real time, and the clients display the first interaction effect and the second interaction effect in real time after receiving the first interaction value and the second interaction value. According to the solution of the embodiment, the performance of the server is fully utilized without considering a synchronization mechanism with the clients or current display states of the clients. Moreover, the client can display, in real time, the first interaction value and the second interaction value received from the server, so that the clients can support high-frequency object interaction, making it easier and smoother to present the effect of two fighters continuously attacking each other at a fixed firing interval.

Optionally, the determining step S101 further includes determining a first hit rate of the first virtual object and a second hit rate of the second virtual object. The display step S105 further includes displaying the corresponding first interaction effect on the second virtual object based on the first hit rate and the first interaction value, and displaying the corresponding second interaction effect on the first virtual object based on the second hit rate and the second interaction value.

Continuing with the above example, the client may display the damage value on the fighter only when the fighter is hit. The first hit rate and the second hit rate may be preset in the server or the client, and a value range may be set from 0% to 100%. When the damage value is calculated, the first damage value is calculated according to the first hit rate. Herein, instead of simply multiplying the first hit rate by an initial first damage value, random calculation is performed according to a probability corresponding to the first hit rate to obtain a result indicating whether the attack hits or not. If yes, the first interaction effect is displayed by taking the initial first damage value as the first interaction value. If not, the first damage value is zero and the first interaction effect is no longer displayed. In other embodiments of the present disclosure, an expected damage value may be obtained by multiplying the first hit rate by the first damage value, and the expected damage value is a real damage value to the second virtual object.

In some embodiments, when the first virtual object hits the second virtual object, a special effect of hitting and the first interaction value are displayed on the second virtual object, and when the second virtual object hits the first virtual object, a special effect of hitting and the second interaction value are displayed on the first virtual object.

Continuing with the above example, the client may display the damage value on the fighter when the fighter is hit, and may also play a special effect of hitting (such as sparks and smoke). Playback judgment logic of the special effect of hitting is consistent with display logic of the first interaction value and the second interaction value. Animation or screen effect resources of the special effect of hitting are stored in the clients. In the case of hitting, relevant resources are retrieved from memories of the clients and rendered for playback.

FIG. 2 is another flowchart of a virtual object interaction control method according to embodiments of the present disclosure. As shown in FIG. 2, the method provided in a second embodiment includes the following steps.

In a determining step S201, a first virtual object and a second virtual object to interact with each other are determined.

Virtual objects refer to controllable objects in a game program executed on clients, including virtual characters, virtual items, and the like. For example, for two or two groups of fighters in a war game that attack each other alternately at a fixed firing interval, the clients may determine that the two or two groups of fighters may be the first virtual object and the second virtual object to interact with each other, and the first virtual object and the second virtual object may attack each other at a fixed interval cycle. In other words, in the first cycle, the first virtual object attacks the second virtual object, and in this case, the second virtual object does not attack the first virtual object. In the second cycle, the second virtual object attacks the first virtual object, and in this case, the first virtual object does not attack the second virtual object. In the third cycle, the first virtual object continues to attack the second virtual object, and the cycle repeats until one of the first virtual object or the second virtual object is defeated, or both move out of the firing range and are out of the combat. The two or two groups of fighters are controlled by different clients or belong to different game camps. The first virtual object is controlled by a first client, and the second virtual object is controlled by a second client. It may be understood that more virtual objects that interact with each other may be split into multiple pairs of virtual objects that interact with each other.

In addition, the clients may determine the first virtual object and the second virtual object to interact with each other based on a determination rule received in advance from the server or based on a determination rule preset in the game program executed on the clients. For example, the determination rule may be determining that two fighters are the first virtual object and the second virtual object, respectively, when the two fighters controlled by the first client and the second client respectively enter a firing range.

In a receiving step S203, a first interaction value that the first virtual object performs on the second virtual object and a second interaction value that the second virtual object performs on the first virtual object are received.

Continuing with the above example, a damage value caused by each fighter to the opposing fighter may be calculated on the server side based on fight process parameters such as positions, attack values, and defense values of the two fighters. The damage values may be the first interaction value and the second interaction value, and the damage values may be sent to the clients by the server. In this embodiment, the first interaction value is a damage value caused by a fighter corresponding to the first virtual object to a fighter corresponding to the second virtual object, and the second interaction value is a damage value caused by the fighter corresponding to the second virtual object to the fighter corresponding to the first virtual object.

In a display step S205, at least a portion of corresponding first interaction effects are displayed on the second virtual object in a first interaction cycle based on a plurality of first interaction values received before the first interaction cycle, and at least a portion of corresponding second interaction effects are displayed on the first virtual object in a second interaction cycle based on a plurality of second interaction values received before the second interaction cycle.

This embodiment is different from the first embodiment in that the client can store the damage values from the server regularly or irregularly for display in a corresponding interaction cycle (which may also be understood as an attack cycle) in the future. In other words, interaction effect data displayed in the present interaction cycle is from attack behaviors in one or more previous interaction cycles, while damage value calculation and interaction effect display in a same interaction cycle in the first embodiment are performed in real time. This processing manner is suitable for simulation games, especially turn-based attack modes or other alternate attack modes. In the above example, for two fighters entering a close combat or dogfight (also known as a “dog fight”), one fighter may have a chance to attack only by getting behind the other fighter. In other words, there may only be one fighter attacking the other fighter at the same moment, i.e., the two fighters alternately attack each other at a fixed firing interval, as described in the above example. For example, once the two fighters begin to exchange fire, in seconds 0 to 5, i.e., the first interaction cycle, the fighter controlled by the first client attacks the fighter controlled by the second client, in seconds 6 to 10, i.e., the second interaction cycle, the fighter controlled by the second client attacks the fighter controlled by the first client, and so on. The two fighters take turns attacking each other until one is eliminated or the fighters move out of the firing range. This alternate attack mode may be simply understood as a turn-based attack mode. It is to be noted that a real fighter cannon fires very quickly and may attack several times in one second. In order to realistically display the attack effect in the game program, a virtual object of an attacking party may attack multiple times in one attack cycle, which corresponds to a plurality of first interaction values or a plurality of second interaction values. In step S205, first interaction effects or second interaction effects corresponding to the plurality of first interaction values or the plurality of second interaction values may be displayed in one interaction cycle.

Continuing with the above example, the client may display the damage value on the damaged fighter in an attack cycle of each fighter. This process of displaying the damage values is displaying the first interaction effect and the second interaction effect. Correspondingly, the first interaction effect is displayed in the first interaction cycle, and the second interaction effect is displayed in the second interaction cycle. If there are multiple rounds of attacks, interaction effects may be displayed in turn.

Depending on the number of damage values stored before an attack cycle, a duration of an attack cycle, a firing interval of each fighter, and a hit rate of each fighter to be described below, in one attack cycle, all the damage values stored before the attack cycle can be displayed, or only part of the damage values stored before the attack cycle can be displayed.

Therefore, in the second embodiment, the server can calculate the first interaction value and the second interaction value only based on its own calculation model, and periodically send the first interaction value and the second interaction value to the clients according to the synchronization mechanism with the clients. The clients display the first interaction effect and the second interaction effect corresponding to the received first interaction value and second interaction value according to the interaction cycle. The idea of separating damage value calculation from combat effect display fully utilizes the performance of the server. Moreover, the client may first store the first interaction value and the second interaction value received from the server for display in a corresponding interaction cycle in the future, so that the clients can support high-frequency object interaction, making it easier and smoother to present the effect of two fighters alternately attacking each other at a fixed firing interval.

In some embodiments, the determining step S201 further includes determining a first hit rate of the first virtual object and a second hit rate of the second virtual object. The display step S205 further includes displaying at least a portion of corresponding first interaction effects on the second virtual object in a first interaction cycle based on the first hit rate and a plurality of first interaction values received before the first interaction cycle, and displaying at least a portion of corresponding second interaction effects on the first virtual object in a second interaction cycle based on the second hit rate and a plurality of second interaction values received before the second interaction cycle.

Continuing with the above example, the client may display the damage value on the fighter only when the fighter is hit.

In some embodiments, when the first virtual object hits the second virtual object, a special effect of hitting and the first interaction value are displayed on the second virtual object, and when the second virtual object hits the first virtual object, a special effect of hitting and the second interaction value are displayed on the first virtual object.

Continuing with the above example, the client may display the damage value on the fighter when the fighter is hit, and may also play a special effect of hitting (such as sparks and smoke). Playback judgment logic of the special effect of hitting is consistent with display logic of the first interaction value and the second interaction value. Animation or screen effect resources of the special effect of hitting are stored in the clients. In the case of hitting, relevant resources are retrieved from memories of the clients and rendered for playback.

In some embodiments, the first interaction cycle and the second interaction cycle both include a hittable cycle and an unhittable cycle. The at least a portion of the corresponding first interaction effects are displayed on the second virtual object in the hittable cycle of the first interaction cycle based on the first hit rate and the plurality of first interaction values received before the first interaction cycle, and the at least a portion of the corresponding second interaction effects are displayed on the first virtual object in the hittable cycle of the second interaction cycle based on the second hit rate and the plurality of second interaction values received before the second interaction cycle. The first hit rate and the second hit rate are respectively adjusted to 0 in the unhittable cycles of the first interaction cycle and the second interaction cycle.

Continuing with the above example, in order to further simulate a real scenario, the following four time points exist in an attack cycle: an opposing fighter enters a shooting angle, the opposing fighter enters a hit range, the opposing fighter leaves the hit range, and the opposing fighter leaves the shooting angle. A period between the opposing fighter entering the shooting angle and the opposing fighter entering the hit range is an unhittable cycle. A period between the opposing fighter entering the hit range and the opposing fighter leaving the hit range is a hittable cycle. A period between the opposing fighter leaving the hit range and the opposing fighter leaving the shooting angle is an unhittable cycle. In the hittable cycle, an attacking fighter can attack based on a normal hit rate, while in the unhittable cycle, the attacking fighter cannot hit the opposing fighter, which enables the client to display a more realistic aircraft combat scene.

In some embodiments, after all the corresponding first interaction effects are displayed on the second virtual object in the hittable cycle of the first interaction cycle based on the first hit rate and the plurality of first interaction values received before the first interaction cycle, the first hit rate is adjusted to 0, and after all the corresponding second interaction effects are displayed on the first virtual object in the hittable cycle of the second interaction cycle based on the second hit rate and the plurality of second interaction values received before the second interaction cycle, the second hit rate is adjusted to 0.

Continuing with the above example, depending on the number of damage values stored before an attack cycle, a duration of an attack cycle, a firing interval of each fighter, and a hit rate of each fighter, if it is possible to display, within one attack cycle, all the damage values stored before the attack cycle and one or more new damage values have not been received yet, during the remaining time of the attack cycle, by adjusting the hit rate of the attacking fighter to 0, an effect of continuous attack of the fighter can still be displayed in the attack cycle, while avoiding additional damage to the fighter being attacked and waiting for one or more new damage values.

In some embodiments, after all the corresponding first interaction effects are displayed on the second virtual object in the hittable cycle of the first interaction cycle based on the first hit rate and the plurality of first interaction values received before the first interaction cycle, when one or more new first interaction values are received again, the first hit rate is restored and at least a portion of corresponding first interaction effects are displayed on the second virtual object based on the first hit rate and the one or more new first interaction values. After all the corresponding second interaction effects are displayed on the first virtual object in the hittable cycle of the second interaction cycle based on the second hit rate and the plurality of second interaction values received before the second interaction cycle, when one or more new second interaction values are received, the second hit rate is restored and at least a portion of corresponding second interaction effects are displayed on the first virtual object based on the second hit rate and the one or more new second interaction values.

Continuing with the above example, depending on the number of damage values stored before an attack cycle, a duration of an attack cycle, a firing interval of each fighter, and a hit rate of each fighter, if it is possible to display, within one attack cycle, all the damage values stored before the attack cycle and one or more new damage values are received, during the remaining time of the attack cycle, by displaying at least a portion of damage values in advance, an effect of continuous attack of the fighter can still be displayed in the attack cycle, and correct damage to the fighter being attacked is ensured.

In some embodiments, after the at least a portion of the corresponding first interaction effects are displayed on the second virtual object in the hittable cycle of the first interaction cycle based on the first hit rate and the plurality of first interaction values received before the first interaction cycle, the remaining corresponding first interaction effects are continuously displayed on the second virtual object based on the first hit rate in the hittable cycle of a next first interaction cycle, and after the at least a portion of the corresponding second interaction effects are displayed on the first virtual object in the hittable cycle of the second interaction cycle based on the second hit rate and the plurality of second interaction values received before the second interaction cycle, the remaining corresponding second interaction effects are continuously displayed on the first virtual object based on the second hit rate in the hittable cycle of a next second interaction cycle.

Continuing with the above example, depending on the number of damage values stored before an attack cycle, a duration of an attack cycle, a firing interval of each fighter, and a hit rate of each fighter, if only part of the damage values stored before an attack cycle can be displayed in the attack cycle, the remaining damage values that have not been displayed may be displayed first in a next attack cycle, and then newly received one or more damage values before the next attack cycle can be displayed.

It may be understood that the firing interval may alternatively be adjusted to ensure that all damage values stored before an attack cycle are displayed in the attack cycle.

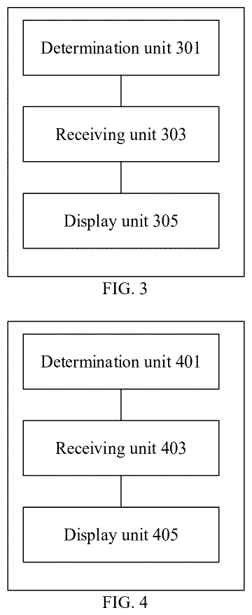

FIG. 3 is a structural diagram of a virtual object interaction control system according to embodiments of the present disclosure. As shown in FIG. 3, the system provided in a third embodiment includes a determination unit 301, a receiving unit 303, and a display unit 305.

The determination unit 301 is configured to determine a first virtual object and a second virtual object to interact with each other.

The receiving unit 303 is configured to receive a first interaction value that the first virtual object performs on the second virtual object, and a second interaction value that the second virtual object performs on the first virtual object.

The display unit 305 is configured to display a corresponding first interaction effect on the second virtual object based on the first interaction value, and display a corresponding second interaction effect on the first virtual object based on the second interaction value.

In some embodiments, the determination unit 301 is further configured to determine a first hit rate of the first virtual object and a second hit rate of the second virtual object. The display unit 305 is further configured to display the corresponding first interaction effect on the second virtual object based on the first hit rate and the first interaction value, and display the corresponding second interaction effect on the first virtual object based on the second hit rate and the second interaction value.

In some embodiments, when the first virtual object hits the second virtual object, a special effect of hitting and the first interaction value are displayed on the second virtual object, and when the second virtual object hits the first virtual object, a special effect of hitting and the second interaction value are displayed on the first virtual object.

The first embodiment is a method embodiment corresponding to this embodiment, and this embodiment may be implemented in cooperation with the first embodiment. The relevant technical details mentioned in the first embodiment are still effective in this embodiment, which is not described herein again in order to reduce repetition. Correspondingly, the relevant technical details mentioned in this embodiment are also applicable to the first embodiment.

FIG. 4 is another structural diagram of a virtual object interaction control system according to embodiments of the present disclosure. As shown in FIG. 4, the system provided in a fourth embodiment includes a determination unit 401, a receiving unit 403, and a display unit 405.

The determination unit 401 is configured to determine a first virtual object and a second virtual object to interact with each other.

The receiving unit 403 is configured to receive a first interaction value that the first virtual object performs on the second virtual object, and a second interaction value that the second virtual object performs on the first virtual object.

The display unit 405 is configured to display at least a portion of corresponding first interaction effects on the second virtual object in a first interaction cycle based on a plurality of first interaction values received before the first interaction cycle, and display at least a portion of corresponding second interaction effects on the first virtual object in a second interaction cycle based on a plurality of second interaction values received before the second interaction cycle.

In some embodiments, the determination unit 401 is further configured to determine a first hit rate of the first virtual object and a second hit rate of the second virtual object. The display unit 405 is further configured to display at least a portion of corresponding first interaction effects on the second virtual object in a first interaction cycle based on the first hit rate and a plurality of first interaction values received before the first interaction cycle, and display at least a portion of corresponding second interaction effects on the first virtual object in a second interaction cycle based on the second hit rate and a plurality of second interaction values received before the second interaction cycle.

In some embodiments, when the first virtual object hits the second virtual object, a special effect of hitting and the first interaction value are displayed on the second virtual object, and when the second virtual object hits the first virtual object, a special effect of hitting and the second interaction value are displayed on the first virtual object.

In some embodiments, the first interaction cycle and the second interaction cycle both include a hittable cycle and an unhittable cycle. The at least a portion of the corresponding first interaction effects are displayed on the second virtual object in the hittable cycle of the first interaction cycle based on the first hit rate and the plurality of first interaction values received before the first interaction cycle, and the at least a portion of the corresponding second interaction effects are displayed on the first virtual object in the hittable cycle of the second interaction cycle based on the second hit rate and the plurality of second interaction values received before the second interaction cycle. The first hit rate and the second hit rate are respectively adjusted to 0 in the unhittable cycles of the first interaction cycle and the second interaction cycle.

In some embodiments, after all the corresponding first interaction effects are displayed on the second virtual object in the hittable cycle of the first interaction cycle based on the first hit rate and the plurality of first interaction values received before the first interaction cycle, the first hit rate is adjusted to 0, and after all the corresponding second interaction effects are displayed on the first virtual object in the hittable cycle of the second interaction cycle based on the second hit rate and the plurality of second interaction values received before the second interaction cycle, the second hit rate is adjusted to 0.

In some embodiments, after all the corresponding first interaction effects are displayed on the second virtual object in the hittable cycle of the first interaction cycle based on the first hit rate and the plurality of first interaction values received before the first interaction cycle, when one or more new first interaction values are received again, the first hit rate is restored and at least a portion of corresponding first interaction effects are displayed on the second virtual object based on the first hit rate and the one or more new first interaction values, and after all the corresponding second interaction effects are displayed on the first virtual object in the hittable cycle of the second interaction cycle based on the second hit rate and the plurality of second interaction values received before the second interaction cycle, when one or more new second interaction values are received again, the second hit rate is restored and at least a portion of corresponding second interaction effects are displayed on the first virtual object based on the second hit rate and the one or more new second interaction values.

The second embodiment is a method embodiment corresponding to this embodiment, and this embodiment may be implemented in cooperation with the second embodiment. The relevant technical details mentioned in the second embodiment are still effective in this embodiment, which is not described herein again in order to reduce repetition. Correspondingly, the relevant technical details mentioned in this embodiment are also applicable to the second embodiment.

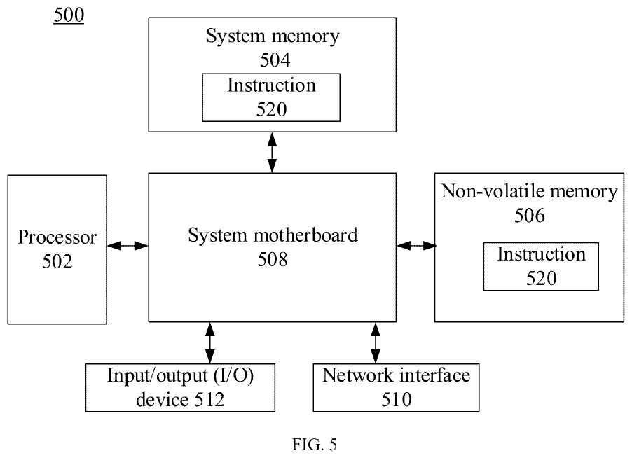

FIG. 5 is a block diagram of a hardware structure of an electronic device configured to implement a virtual object interaction control method according to embodiments of the present disclosure.

As shown in FIG. 5, an electronic device 500 may include one or more processors 502, a system motherboard 508 coupled to at least one of the processors 502, a system memory 504 coupled to the system motherboard 508, a non-volatile memory (NVM) 506 coupled to the system motherboard 508, and a network interface 510 connected to the system motherboard 508.

The processor 502 may include one or more single-core or multi-core processors. The processor 502 may include any combination of a general-purpose processor and a special-purpose processor (e.g., a graphics processor, an application processor, or a baseband processor). In the embodiments of the present disclosure, the processor 502 may be configured to perform one or more embodiments according to various embodiments as shown in FIG. 1 and FIG. 2.

In some embodiments, the system motherboard 508 may include any suitable interface controller to provide any suitable interface for at least one of the processors 502 and/or any suitable device or component in communication with the system motherboard 508.

In some embodiments, the system motherboard 508 may include one or more memory controllers to provide an interface connected to the system memory 504. The system memory 504 may be configured to load and store data and/or instructions. In some embodiments, the system memory 504 of the electronic device 500 may include any suitable volatile memory, such as a suitable dynamic random access memory (DRAM).

The NVM 506 may include one or more tangible and non-transitory computer-readable media configured to store data and/or instructions. In some embodiments, the NVM 506 may include any suitable non-volatile memory such as a flash memory and/or any suitable non-volatile storage device, for example, at least one of a hard disk drive (HDD), a compact disc (CD) drive, and a digital versatile disc (DVD) drive.

The NVM 506 may include part of storage resources on an apparatus installed on the electronic device 500, or may be accessed by the device but is not necessarily part of the device. For example, the NVM 506 may be accessed over a network via the network interface 510.

In particular, the system memory 504 and the NVM 506 may include a temporary copy and a permanent copy of an instruction 520, respectively. The instruction 520 may include an instruction, when executed by at least one of the processors 502, causing the electronic device 500 to implement the methods shown in FIG. 1 and FIG. 2. In some embodiments, the instruction 520, hardware, firmware and/or software components thereof may additionally/alternatively be placed in the system motherboard 508, the network interface 510 and/or the processor 502.

The network interface 510 may include a transceiver configured to provide a radio interface for the electronic device 500 to communicate with any other suitable device (such as a front-end module or an antenna) by using one or more networks. In some embodiments, the network interface 510 may be integrated on another component of the electronic device 500. For example, the network interface 510 may be integrated on at least one of the processor 502, the system memory 504, the NVM 506, and a firmware device (not shown) with instructions. When at least one of the processors 502 executes the instructions, the electronic device 500 implements one or more of the various embodiments shown in FIG. 1 and FIG. 2.

The network interface 510 may further include any suitable hardware and/or firmware to provide a multi-input multi-output radio interface. For example, the network interface 510 may be a network adapter, a wireless network adapter, a telephone modem, and/or a wireless modem.

In an embodiment, at least one of the processors 502 may be packaged with one or more controllers for the system motherboard 508 to form a system in package (SiP). In an embodiment, at least one of the processors 502 may be integrated on the same die with one or more controllers for the system motherboard 508 to form a system on chip (SoC).

The electronic device 500 may further include an input/output (I/O) device 512 connected to the system motherboard 508. The I/O device 512 may include a user interface to enable a user to interact with the electronic device 500. The design of a peripheral component interface enables a peripheral component to also interact with the electronic device 500. In some embodiments, the electronic device 500 further includes a sensor configured to determine at least one of an environmental condition and position information related to the electronic device 500.

In some embodiments, the I/O device 512 may include, but is not limited to, a display (e.g., a liquid crystal display or a touch screen display), a speaker, a microphone, one or more cameras (e.g., a still-picture camera and/or a video camera), a flashlight (e.g., a light-emitting diode flash), and a keyboard.

In some embodiments, the peripheral component interface may include, but is not limited to, a non-volatile memory port, an audio jack, and a power interface.

In some embodiments, the sensor may include, but is not limited to, a gyro sensor, an accelerometer, a proximity sensor, an ambient light sensor, and a positioning unit. The positioning unit may alternatively be part of the network interface 510 or interact with the network interface 510 to communicate with components (for example, global positioning system (GPS) satellites) of a positioning network.

It may be understood that the structure shown in the embodiments of the present disclosure does not constitute a specific limitation on the electronic device 500. In some other embodiments of the present disclosure, the electronic device 500 may include more or fewer components than those shown in the figure, combine some components, split some components, or have different component arrangements. The components shown in the figure may be implemented by using hardware, software, or a combination of software and hardware.

Program code may be applied to input instructions to perform the functions described in the present disclosure and generate output information. The output information may be applied to one or more output devices in a known manner. For the purposes of the present disclosure, a system including the processor 502 and configured to process instructions includes any system having a processor such as a digital signal processor (DSP), a microcontroller, an application-specific integrated circuit (ASIC), or a microprocessor.

The program code may be implemented in a high-level programming language or an object-oriented programming language to communicate with the processing system. When necessary, an assembly language or machine language may also be used to implement the program code. In fact, the mechanism described in the present disclosure is not limited to the scope of any particular programming language. In any case, the language may be a compiled language or an interpreted language.

One or more aspects of at least one embodiment may be implemented by instructions stored in a computer-readable storage medium. The instructions, when read and executed by a processor, enable the electronic device to implement the method in the embodiments described in the present disclosure.

The present disclosure further provides a computer-readable storage medium, having computer-executable instructions stored therein. The instructions are executed by a processor to implement the virtual object interaction control method described above.

The present disclosure further provides a computer program product. The computer program product includes computer-executable instructions. The instructions are executed by a processor to implement the virtual object interaction control method described above.

Compared with the conventional technology, implementations of the present disclosure have the following main differences and effects.

The server can calculate the first interaction value and the second interaction value only based on its own calculation model without considering a synchronization mechanism with the clients or current display states of the clients, and the performance of the server is fully utilized. Moreover, the client may display, in real time, the first interaction value and the second interaction value received from the server, or the client may first store the first interaction value and the second interaction value received from the server for display in a corresponding interaction cycle in the future, so that the clients can support high-frequency object interaction, making it easier and smoother to present the effect of two fighters continuously attacking each other or alternating attacking each other at a fixed firing interval.

Although the present disclosure has been illustrated and described with reference to some preferred embodiments of the present disclosure, those of ordinary skill in the art may understand that various changes may be made in form and details without departing from the spirit and scope of the present disclosure.

What is claimed is:

1. A virtual object interaction control method, applied to an electronic device, wherein the method comprises:
a determining step of determining a first virtual object and a second virtual object to interact with each other;
a receiving step of receiving a first interaction value that the first virtual object performs on the second virtual object and a second interaction value that the second virtual object performs on the first virtual object; and
a display step of displaying a corresponding first interaction effect on the second virtual object based on the first interaction value and displaying a corresponding second interaction effect on the first virtual object based on the second interaction value.

2. The method according to claim 1, wherein the determining step further comprises determining a first hit rate of the first virtual object and a second hit rate of the second virtual object, and wherein the display step further comprises displaying the corresponding first interaction effect on the second virtual object based on the first hit rate and the first interaction value and displaying the corresponding second interaction effect on the first virtual object based on the second hit rate and the second interaction value.

3. The method according to claim 2, wherein the display step further comprises displaying at least a portion of corresponding first interaction effects on the second virtual object in a first interaction cycle based on the first hit rate and a plurality of first interaction values received before the first interaction cycle, and displaying at least a portion of corresponding second interaction effects on the first virtual object in a second interaction cycle based on the second hit rate and a plurality of second interaction values received before the second interaction cycle.

4. The method according to claim 3, wherein the first interaction cycle and the second interaction cycle both comprise a hittable cycle and an unhittable cycle, wherein the at least a portion of the corresponding first interaction effects are displayed on the second virtual object in the hittable cycle of the first interaction cycle based on the first hit rate and the plurality of first interaction values received before the first interaction cycle, and the at least a portion of the corresponding second interaction effects are displayed on the first virtual object in the hittable cycle of the second interaction cycle based on the second hit rate and the plurality of second interaction values received before the second interaction cycle, and wherein the first hit rate and the second hit rate are respectively adjusted to 0 in the unhittable cycles of the first interaction cycle and the second interaction cycle.

5. The method according to claim 4, wherein after all the corresponding first interaction effects are displayed on the second virtual object in the hittable cycle of the first interaction cycle based on the first hit rate and the plurality of first interaction values received before the first interaction cycle, the first hit rate is adjusted to 0, and after all the corresponding second interaction effects are displayed on the first virtual object in the hittable cycle of the second interaction cycle based on the second hit rate and the plurality of second interaction values received before the second interaction cycle, the second hit rate is adjusted to 0.

6. The method according to claim 5, wherein after all the corresponding first interaction effects are displayed on the second virtual object in the hittable cycle of the first interaction cycle based on the first hit rate and the plurality of first interaction values received before the first interaction cycle, when one or more new first interaction values are received the first hit rate is restored and at least a portion of corresponding first interaction effects are displayed on the second virtual object based on the first hit rate and the one or more new first interaction values, and after all the corresponding second interaction effects are displayed on the first virtual object in the hittable cycle of the second interaction cycle based on the second hit rate and the plurality of second interaction values received before the second interaction cycle, when one or more new second interaction values are received the second hit rate is restored and at least a portion of corresponding second interaction effects are displayed on the first virtual object based on the second hit rate and the one or more new second interaction values.

7. The method according to claim 4, wherein after the at least a portion of the corresponding first interaction effects are displayed on the second virtual object in the hittable cycle of the first interaction cycle based on the first hit rate and the plurality of first interaction values received before the first interaction cycle, the remaining corresponding first interaction effects are continuously displayed on the second virtual object based on the first hit rate in the hittable cycle of a next first interaction cycle, and after the at least a portion of the corresponding second interaction effects are displayed on the first virtual object in the hittable cycle of the second interaction cycle based on the second hit rate and the plurality of second interaction values received before the second interaction cycle, the remaining corresponding second interaction effects are continuously displayed on the first virtual object based on the second hit rate in the hittable cycle of a next second interaction cycle.

8. An electronic device, wherein the electronic device comprises a processor and a memory storing a computer-executable instruction, the processor being configured to execute the instruction to implement a virtual object interaction control method wherein the method comprises:
a determining step of determining a first virtual object and a second virtual object to interact with each other;
a receiving step of receiving a first interaction value that the first virtual object performs on the second virtual object and a second interaction value that the second virtual object performs on the first virtual object; and
a display step of displaying a corresponding first interaction effect on the second virtual object based on the first interaction value and displaying a corresponding second interaction effect on the first virtual object based on the second interaction value.

9. A non-transitory_computer-readable storage medium, having a computer-executable instruction stored therein, wherein the instruction is executed by a processor to implement the virtual object interaction control method according to claim 1.

10. A computer program product, comprising a computer-executable instruction, wherein the instruction is executed by a processor to implement the virtual object interaction control method according to claim 1.

11. The method according to claim 1, wherein the display step further comprises:
displaying at least a portion of corresponding first interaction effects on the second virtual object in a first interaction cycle based on a plurality of first interaction values received before the first interaction cycle, and displaying at least a portion of the corresponding second interaction effects on the first virtual object in a second interaction cycle based on a plurality of second interaction values received before the second interaction cycle.

12. The electronic device according to claim 8, wherein the determining step further comprises determining a first hit rate of the first virtual object and a second hit rate of the second virtual object, and wherein the display step further comprises displaying the corresponding first interaction effect on the second virtual object based on the first hit rate and the first interaction value and displaying the corresponding second interaction effect on the first virtual object based on the second hit rate and the second interaction value.

13. The electronic device according to claim 12, wherein the display step further comprises displaying at least a portion of corresponding first interaction effects on the second virtual object in a first interaction cycle based on the first hit rate and a plurality of first interaction values received before the first interaction cycle, and displaying at least a portion of corresponding second interaction effects on the first virtual object in a second interaction cycle based on the second hit rate and a plurality of second interaction values received before the second interaction cycle.

14. The electronic device according to claim 13, wherein the first interaction cycle and the second interaction cycle both comprise a hittable cycle and an unhittable cycle, wherein the at least a portion of the corresponding first interaction effects are displayed on the second virtual object in the hittable cycle of the first interaction cycle based on the first hit rate and the plurality of first interaction values received before the first interaction cycle, and the at least a portion of the corresponding second interaction effects are displayed on the first virtual object in the hittable cycle of the second interaction cycle based on the second hit rate and the plurality of second interaction values received before the second interaction cycle, and wherein the first hit rate and the second hit rate are respectively adjusted to 0 in the unhittable cycles of the first interaction cycle and the second interaction cycle.

15. The electronic device according to claim 14, wherein the method further comprises: after all the corresponding first interaction effects are displayed on the second virtual object in the hittable cycle of the first interaction cycle based on the first hit rate and the plurality of first interaction values received before the first interaction cycle, adjusting the first hit rate to 0, and after all the corresponding second interaction effects are displayed on the first virtual object in the hittable cycle of the second interaction cycle based on the second hit rate and the plurality of second interaction values received before the second interaction cycle, adjusting the second hit rate to 0.

16. The electronic device according to claim 15, wherein the method further comprises:
after all the corresponding first interaction effects are displayed on the second virtual object in the hittable cycle of the first interaction cycle based on the first hit rate and the plurality of first interaction values received before the first interaction cycle, when one or more new first interaction values are received, restoring the first hit rate and displaying at least a portion of corresponding first interaction effects on the second virtual object based on the first hit rate and the one or more new first interaction values; and
after all the corresponding second interaction effects are displayed on the first virtual object in the hittable cycle of the second interaction cycle based on the second hit rate and the plurality of second interaction values received before the second interaction cycle, when one or more new second interaction values are received, restoring the second hit rate and displaying at least a portion of corresponding second interaction effects the first virtual object based on the second hit rate and the one or more new second interaction values.

17. The electronic device according to claim 14, wherein the method further comprises:
after the at least a portion of the corresponding first interaction effects are displayed on the second virtual object in the hittable cycle of the first interaction cycle based on the first hit rate and the plurality of first interaction values received before the first interaction cycle, continuously displaying the remaining corresponding first interaction effects on the second virtual object based on the first hit rate in the hittable cycle of a next first interaction cycle; and
after the at least a portion of the corresponding second interaction effects are displayed on the first virtual object in the hittable cycle of the second interaction cycle based on the second hit rate and the plurality of second interaction values received before the second interaction cycle, continuously displaying the remaining corresponding second interaction effects on the first virtual object based on the second hit rate in the hittable cycle of a next second interaction cycle.

18. The electronic device according to claim 8, wherein the display step of the method further comprises:
displaying at least a portion of corresponding first interaction effects on the second virtual object in a first interaction cycle based on a plurality of first interaction values received before the first interaction cycle, and displaying at least a portion of the corresponding second interaction effects on the first virtual object in a second interaction cycle based on a plurality of second interaction values received before the second interaction cycle.
